(19) United States
(12) Patent Application Publication
(10) Pub. No.: US 2008/0121853 A1
(43) Pub. Date: May 29, 2008

(54) Heavy-Duty In-Vehicle Lift Mechanism

(76) Inventors: Timothy D. Schultz, Mishawaka, IN (US); Nikesh Bakshi, Granger, IN (US); David A. Kolberg, Granger, IN (US); Gary D. Peter, Middlebury, IN (US); Clarence M. Stinnett, Granger, IN (US)

Correspondence Address: QUARLES & BRADY LLP, 411 E. WISCONSIN AVENUE, SUITE 2040, MILWAUKEE, WI, 53202-4497, US

(21) Appl. No.: 11/771,619

(22) Filed: Jun. 29, 2007

Related U.S. Application Data
(60) Provisional application No. 60/806,359, filed on Jun. 30, 2006.

(51) Int. Cl. B66F 7/28

(52) U.S. Cl. 254/264

(57) ABSTRACT

An in-vehicle lift mechanism has a heavy duty drive assembly suitable for lifting heavy loads, such as all terrain vehicles, motorcycles and other motorized equipment and vehicles. The lift mechanism has four corner posts that are fixed to the vehicle and guide a support platform. The drive assembly includes a motor that drives a screw to engage a nut secured to a movable pulley carriage. As the screw turns, the pulley carriage translates relative the platform to either let out or take up cabling allowing the platform to be raised or lowered. The mechanism uses multiple cables, the ends of which are secured in fixed positions, one end being fixed relative to the platform and one fixed relative to the vehicle. A plurality of stationary position pulleys route the cables between the platform and the posts.

### CROSS-REFERENCE TO RELATED APPLICATION

This application claims benefit to U.S. Provisional Patent Application No. 60/806,359, filed on Jun. 30, 2006.

### STATEMENT OF FEDERALLY SPONSORED RESEARCH OR DEVELOPMENT

Not applicable.

### BACKGROUND OF THE INVENTION

1. Technical Field

The present invention relates to recreational vehicles, and more particularly to lifting mechanisms for raising and lowering objects, particularly heavy loads, within the interiors of such vehicles.

2. Description of the Related Art

In order to increase the available interior space of recreational vehicles or trailers, slide-out sections, such as rooms or closets, can be made integral with the structure of the vehicle or trailer. These slide-out sections usually include a floor, a roof, an end wall and one or more side walls. In the retracted position the roof, floor and side walls are typically inside the vehicle, concealed from exterior view, and the end wall forms a portion of the vehicle's exterior side wall. During transit, these sections are retracted and stored in the interior of the vehicle, with the exterior wall of the slide-out section being flush with the exterior of the vehicle. To use the slide-out section, the vehicle is first parked and leveled. The slide-out room is then slid outward from the vehicle, thereby increasing the interior space of the vehicle. Various drive assemblies exist to extend and retract the slide-out sections. These drive assemblies can be manual or powered, including hydraulics, pneumatics, electronics, simple gearing mechanisms, cable and pulley arrangements, or various combinations thereof. U.S. Pat. No. 6,254,171 discloses one type of operating mechanism for a slide-out room. Slide-out room assemblies can add prohibitive cost and weight to a vehicle such that other methods must be employed to increase interior seating and like space. Moreover, even if the vehicle is equipped with a slide-out room additional interior space may be desired in the slide-out room.

Another way to increase interior space in such vehicles is to change the vertical position of certain objects at the vehicle interior, such as furniture and other such items. The objects can be raised out of the way when not used, but otherwise lowered while being used. This allows floor space and living space to be cleared of unnecessary objects without eliminating the presence of those objects from within the vehicle.

In-vehicle lift mechanisms of the type that are mounted within the interior of a trailer or other vehicle for raising and lowering a platform are known. U.S. Provisional Patent Application No. 60/584,625, filed Jul. 1, 2004, describes one such lift mechanism, which is specially suited for raising and lowering furniture such as a bunk bed and therefore it has a capacity to suit that function, for example approximately 300 pounds. This application is hereby incorporated by reference as if fully set forth herein for its disclosure of the lift mechanism.

A need exists for a heavy duty lift mechanism that is capable of lifting heavier loads, such as an all terrain vehicle, motorcycles, and the like, items which are likely to be put into a recreational vehicle, trailer, or “toy hauler”, to more efficiently use the volume within the trailer or other vehicle.

### SUMMARY OF THE INVENTION

The present invention provides a lift mechanism for raising and lowering a platform in an interior of the vehicle. The lift mechanism includes a frame and a support member supporting the platform and connected to the frame to be vertically movable relative to the frame. It has a drive assembly that drives an elongated flexible member with a first end fixed relative to the frame or vehicle and a second end fixed relative to the platform support. The flexible member is engaged between its ends by at least one movable position guide member and at least one stationary guide member directing the flexible member through at least one turn. The drive assembly moves the movable position guide member relative to the support member to cause the flexible member to adjust the height of the support member.

The drive assembly can be mounted to the platform or platform support member, and can include a motor drive, a drive screw and a drive nut engaging the drive screw so that they are relatively rotatable. The position of either the drive screw or the drive nut is fixed with respect to the movable guide member, and the motor drive turns the other. For example, the motor drive can turn the drive screw so the drive nut and the movable guide member translate along the length of the drive screw.

The lift mechanism can also include a carriage rotatably mounting the movable guide member(s) that moves with respect to the support member. The carriage fixedly mounts either the drive nut or the drive screw and travels relative to the support member by the motor rotating the complementary drive screw or nut component.

The flexible member can be cabling, in one or more sections, and the movable and stationary guide members can be rotatable sheaves or pulleys. Preferably, the cabling includes multiple segments or section, each having one end fixed relative to the support member and another end fixed relative to the vehicle.

The plurality of movable and stationary sheaves, such as in one preferred form there are at least ten that are stationary and at least two that are movable, define the cable pathway that routes the cable sections from where they are fixed on the support member through the upright posts of the frame to the fixed points on the frame or vehicle.

Thus, in one preferred form, operation of the drive motor turns the drive screw. The drive screw threads engage the nut fixed in the carriage and cause the carriage to translate along the drive screw relative to the support member. Because one end of each cable is fixed relative to the support member and the other is fixed relative to the vehicle, movement of the carriage (and sheaves mounted thereon) cause the drive assembly to either take up or let out cabling in the vertical direction, and thereby raise or lower the support member.

The lift mechanism can also include a travel lock out mechanism and a stop mechanism. The travel lock out mechanism prevents the support member from moving relative to the frame. It can have a solenoid that extends and retracts an arm. The solenoid can be mounted to the support member or the frame to engage one or more associated openings in the frame or support member, respectively. The openings can be spaced apart vertically along the vertical posts of the frame so that the support member can be locked at various heights.

The stop mechanism prevents operation of the drive assembly when an object is beneath the support member. The stop mechanism can be any suitable sensing device, such as a pressure sensitive switch, a light beam and reflector assembly, a photo-eye, and a proximity sensor, that opens the electrical circuit or provides an input signal to a controller for the drive motor so that support member is either stopped or raised when an object is detected beneath the support member.

The foregoing and other advantages of the invention will appear in the detailed description which follows. In the description, reference is made to the accompanying drawings which illustrate a preferred embodiment of the invention.

### BRIEF DESCRIPTION OF THE DRAWINGS

FIG. 1 is a perspective view of a heavy duty lift mechanism for an interior of a vehicle;

FIG. 2 is a plan view thereof;

FIG. 3 is a simplified perspective view showing a cable and drive assembly of the lift mechanism with a support platform (in phantom) shown in a lowered position;

FIG. 4 is a view similar to FIG. 3 albeit with the support platform in a raised position;

FIG. 5 is a sectional view taken along line 5-5 of FIG. 2;

FIG. 6 is a sectional view taken along line 6-6 of FIG. 2;

FIG. 7 is a partial enlarged perspective view showing a pulley carriage of the drive assembly;

FIG. 8 is a partial sectional view taken along line 8-8 of FIG. 2;

FIG. 9 is a partial sectional view taken along line 9-9 of FIG. 2 showing a stop mechanism in an engaged position;

FIG. 10 is a view similar to FIG. 9 albeit showing the stop mechanism in a disengaged position; and

FIG. 11 is a partial sectional view taken along line 11-11 of FIG. 10.

### DETAILED DESCRIPTION OF THE PREFERRED EMBODIMENT

Although not shown in the drawings, the present invention is preferably used in a passenger vehicle, such as a tow-along trailer or self-propelled (motorhome) recreational vehicle. The lift mechanism's 10 robust framing and drive assembly allow it to be used advantageously to vertically elevate heavier loads, on the order of 1,000-2,000 pound loads, such as all terrain vehicle, motorcycles, and the like, and thereby clear floor space in the interior of the vehicle.

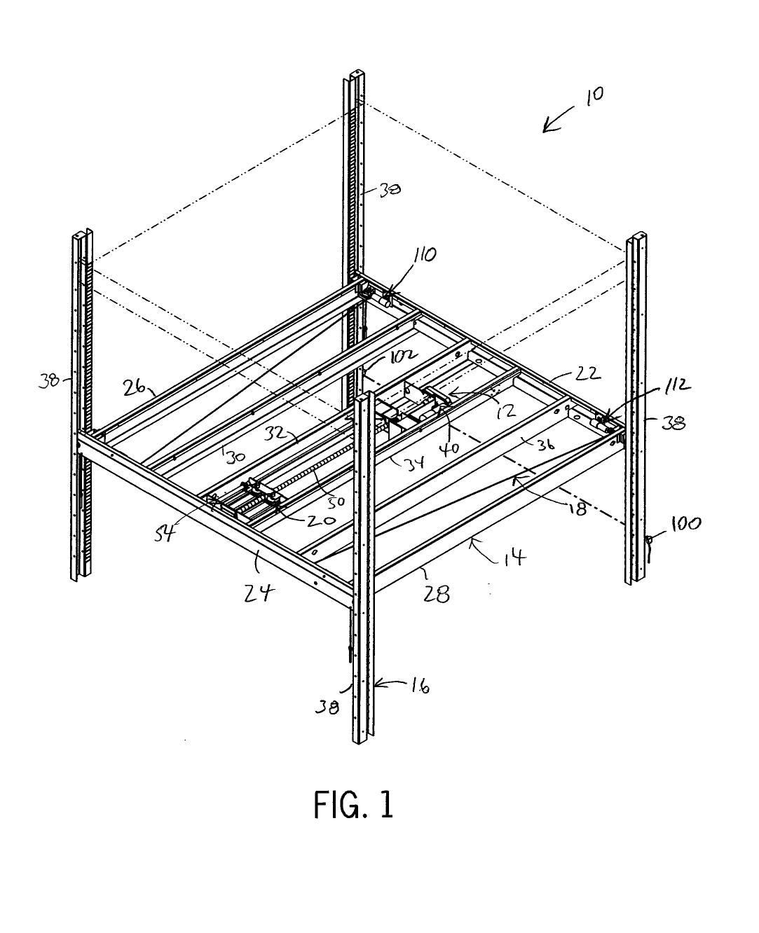

FIG. 1 shows the lift mechanism 10 inverted in what would be an elevated position if not inverted. The lift mechanism 10 can be mounted inside the main vehicle interior or within an extendable and retractable slide-out section of the vehicle to provide further space-saving benefits. Such slide-out sections are well known to have a floor, ceiling, upright end wall and two upright side walls, which form a part of the vehicle exterior when extended.

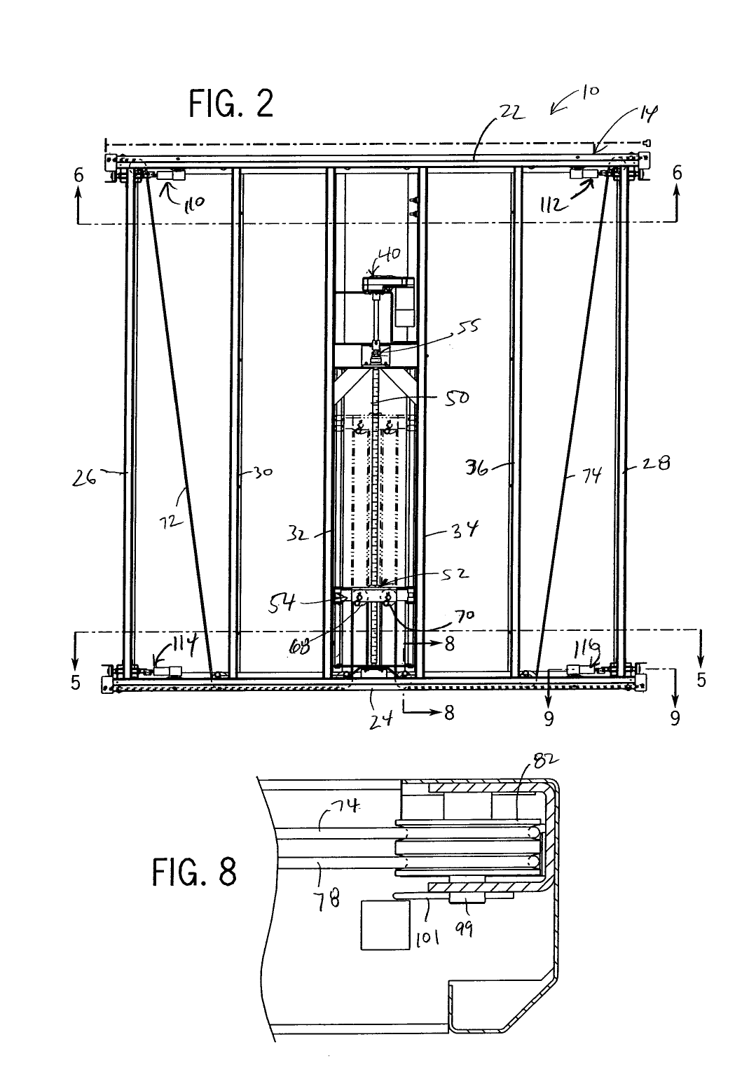

Referring now to FIGS. 1 and 2, the primary components of the lift mechanism 10 include a drive assembly 12, a support platform 14, an upright frame assembly 16, a flexible drive assembly 18 and a guide assembly 20. The support platform 14 is a framework of channel members including front 22 and back 24 runners and end channels 26 and 28 and inner channels 30, 32, 34 and 36. The channels are joined in any suitable manner, such as by weldment or mechanical fasteners, using any standard joinery, such as overlapped or recessed joints.

As shown in FIG. 1, the upright frame assembly 16 includes four vertical channel members 38 at the four corners of the support platform 14. The open faces of these channels 38 receive the ends of the front 22 and back 24 channels allowing the support platform 14 to move up and down therein. Wear pads (not shown) can be mounted to the channels, or any bushings, rollers or other friction reducing members, can be used at this junction to facilitate easier and smoother movement. The channels 38 of the upright frame assembly 16 are bolted or otherwise fixed to opposite side walls of the vehicle room or to the floor and/or the ceiling at opposite ends. The top and bottom ends of these channels 38 may be either capped, have clearance or run full height of the room so that the support platform 14 can not be decoupled readily. “Feet” (not shown) at either the bottom, top or both ends of the vertical channels if the lift mechanism is mounted to the floor, ceiling or floor and ceiling, respectively. Each foot can be a solid steel piece or a stack of steel pieces that are disposed between the vertical channels and the flooring or joists or other structural parts of the floor and ceiling. This can provide a more solid connection to the vehicle that mounting the vertical channels to the side walls of the vehicle room, which may have less robust tubular structural members.

The height adjustment of the support platform 14 is accomplished by actuating the drive assembly 12 to move the flexible drive assembly 18. As shown in FIGS. 1 and 2, the drive unit 12 is preferably a suitable bidirectional electric motor and gear box drive unit 40 bolted to a motor mount flange that is welded to the support platform 14 between the innermost channels 32 and 34. The motor drive unit 40 turns a long drive screw 50 that threads into a drive nut 52 mounted in a traveling pulley carriage 54. To bear the force of heavier loads (e.g., 1,000-2,000 lbs. or greater) carried by the support platform 14, the drive screw 50 should mount via a spherical thrust bearing of tapered or cylindrical roller type and an angular compensating washer configuration 55, which preferably includes a roller bearing, a spherical washer and a thrust bushing. This assembly allows the high thrust loading of the higher platform loads to be transferred successfully to the motor/gear box of the drive unit 40.

The drive unit 40 is mounted in fixed relation to the support platform 14, and the carriage 54 translates with respect to the support platform 14 along the drive screw 50 as it is turned because the drive nut 52 is held in the carriage 54 against rotation so that the drive screw 50 turns relative to the drive nut 52. As shown in FIG. 7, the carriage 54 has two support tubes 60 and 62 that extend between two end brackets 64 and 66. The end bracket 66 mounts two double groove sheaves or pulleys 68 and 70, which move along with the carriage 54 and can rotate about a vertical axis relative to the carriage 54.

As mentioned, operation of the drive unit 40 turns the drive screw 50 which moves the flexible drive assembly 18. As shown in FIGS. 2-4, in the preferred embodiment the flexible drive assembly 18 is an assembly of four cables, including two long cables 72 and 74 and two shorter cables 76 and 78. One end of each cable 72-78 is fixed to a plate 79 mounted to the support platform 14. The other end of each cable 72-78 is fixed either to an upper end of the upright frame assembly 16 or to the vehicle room frame (such as ceiling joists).

Rotation of the drive screw 50 by the drive unit 40 causes the carriage 54 to travel along the drive screw 50 toward the drive unit 40, which has the effect of taking up cable and thereby raises the support platform 14 upward. The opposite rotation of the drive screw 50 causes the carriage 54 to travel along the drive screw 50 away from the drive unit 40 which lets out cable and lowers the support platform 14.

As the support platform 14 is raised and lowered, the cables 72-78 of the flexible drive assembly 18 move around the support platform 14 and upright frame assembly 16 as directed by the guide assembly 20, and thereby raise or lower the support platform 14.

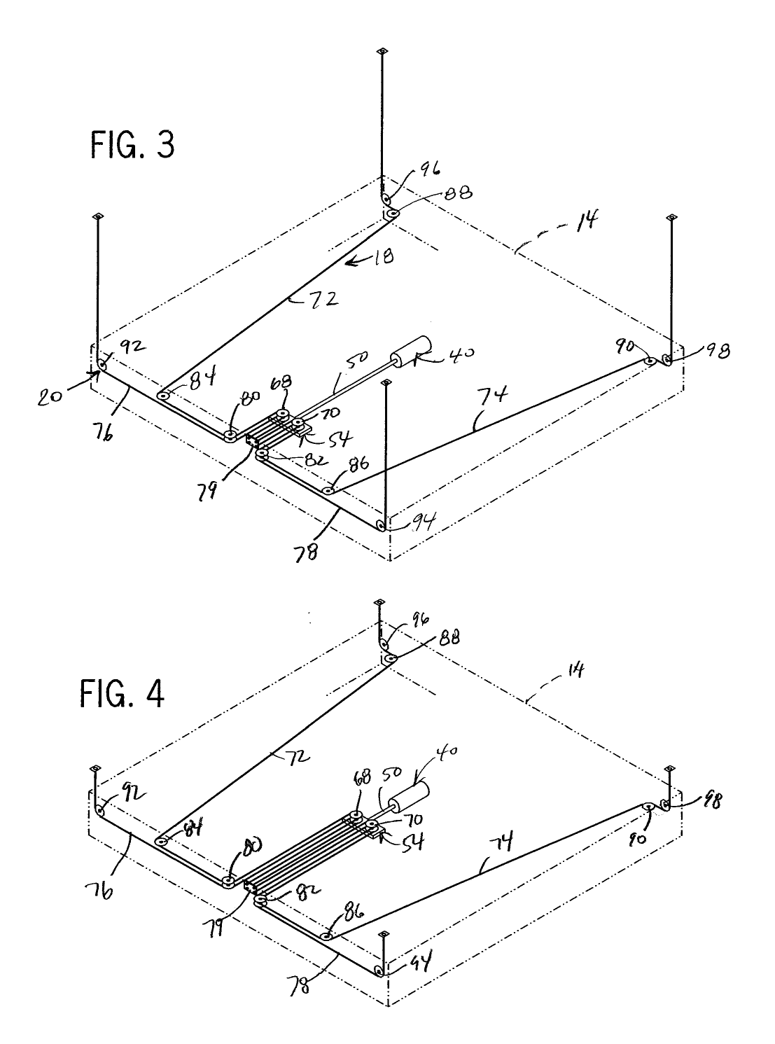

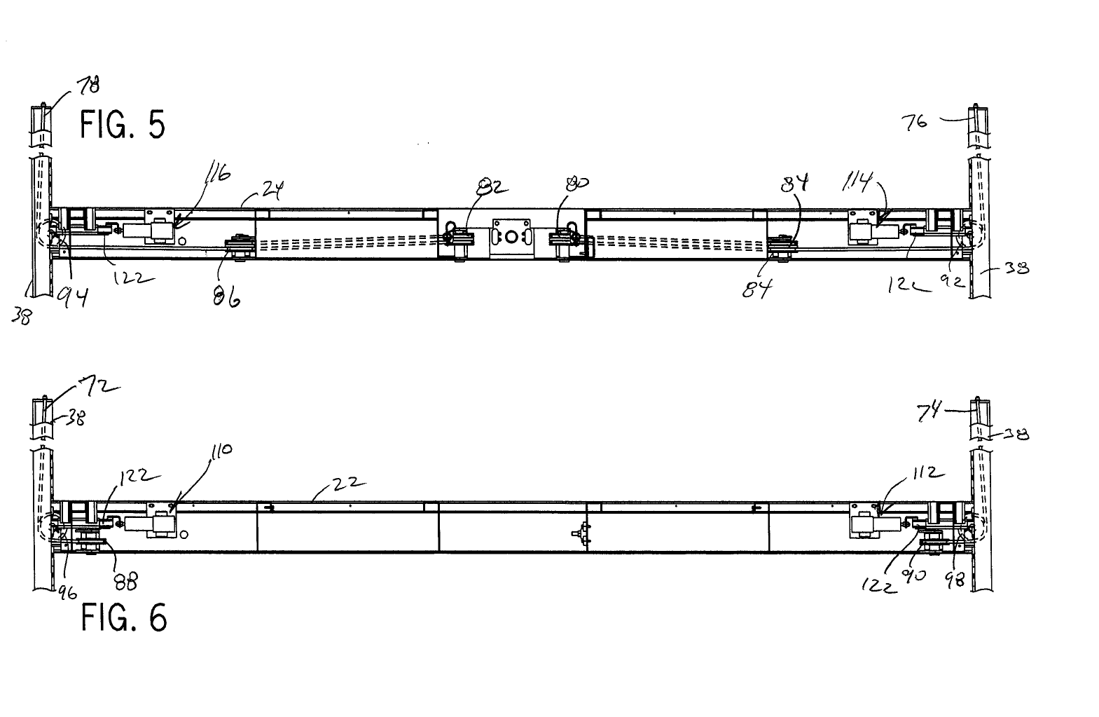

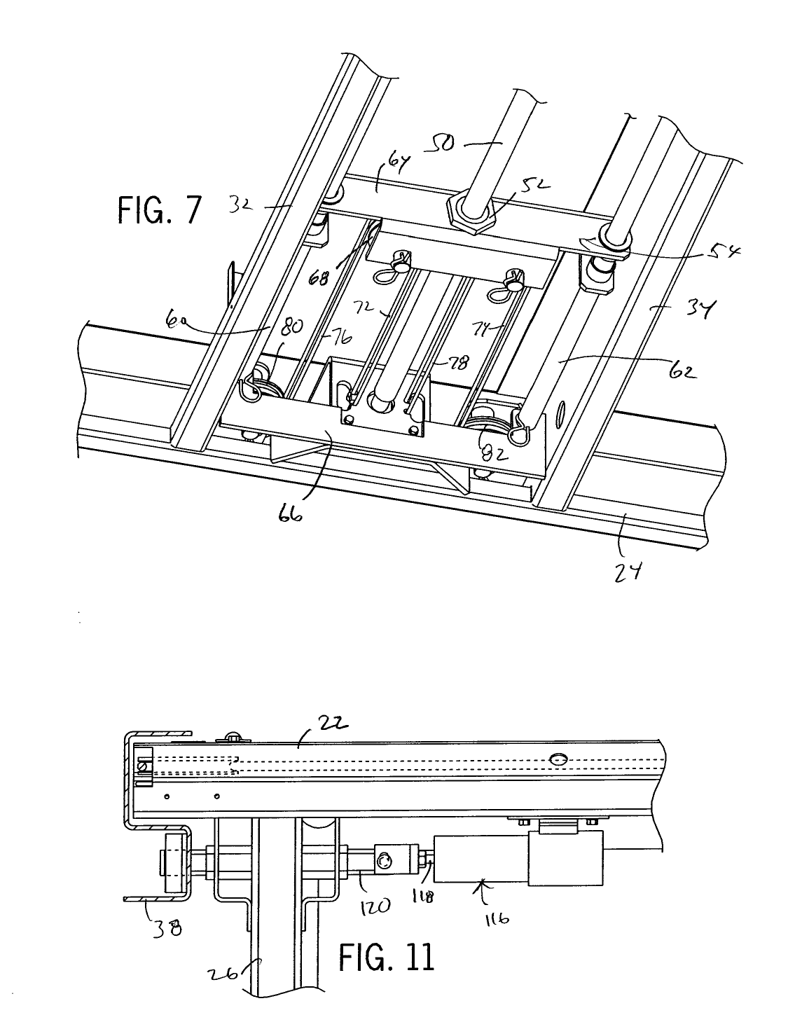

As shown in FIGS. 3-7, the guide assembly 20 includes number of pulleys or sheaves, including both the movable position pulleys 68 and 70 as well as ten stationary pulleys 80-98, all of which can be rotatable mounted on stub shafts 99 and retained by clip pins 101 (see FIG. 8). Like the movable pulleys 68 and 70, stationary pulleys 80 and 82 are double grooved, each engaging two of the cables. All of the other stationary pulleys 84-98 are single grooves, each engaging only one cable. The two double groove stationary pulleys 80 and 82 and single groove stationary pulleys 84, 86, 88 and 90 are mounted to the support platform 14 to rotate about vertical axes. Singe groove stationary pulleys 92-98 are mounted to the support platform 14 to rotate about horizontal axes.

The arrangement of the guide assembly 20 defines the cable pathway as shown in FIGS. 3 and 4. The guide assembly 20 routes the cables 72-78 from the carriage 54 generally through the horizontal plane of the support platform 14 and then up vertically through the upright frame assembly 16. In particular, all of the cables 72-78 extend from the fixed plate 79 and wrap 180 degrees around the two double groove movable pulleys 68 and 70 on the carriage 54, with long 72 and short 76 cables engaging pulley 68 and long 74 and short 78 cables engaging pulley 70. Then, the cables engage the associated stationary double groove pulleys 80 and 82 and turn 90 degrees generally along member 24 of the support platform 14. The long cables 72 and 74 engage pulleys 84 and 86, and run back at an oblique angle to pulleys 88 and 90, respectively, at the rear corners of the support platform 14, then turn upward by wrapping 90 degrees around pulleys 96 and 98, respectively. The short cables 76 and 76 run from the stationary double groove pulleys 80 and 82 and engage pulleys 92 and 94, respectively, at two corners of the support platform 14 where they turn 90 degrees upwardly.

In the preferred embodiment, translation of the pulley carriage 54 along the drive screw 50 causes the support platform 14 to be raised or lowered. The particular pulley arrangement described herein causes the support platform 14 to move about twice the distance that the carriage 50 travels.

Thus, an object can be raised up out of the way when not being used, which increases the effective living and floor space in the room inside the vehicle. When needed, it can be lowered into place for use. The operation can be performed using a simple wall switch mounted in a convenient location. The robust drive screw/nut and traveling pulley carriage arrangement allows the mechanism to lift heavier loads, such as an all terrain vehicle, motorcycles, and the like, items which are likely to be put into a recreational vehicle or trailer to more efficiently use the volume within the trailer or other vehicle.

The lift mechanism of the present invention can include additional safety features designed to prevent the support platform 14 from inadvertently lowering, particularly when an object or person is located below the support platform 14. Various space monitoring devices, such as photo-sensors and the like, can be used to prevent the support platform 14 from being lowered when objects or people are in the space directly below it.

As shown in FIG. 1, in the preferred embodiment described herein, the lift mechanism has a stop mechanism in which a compact light beam generator 100, as know in the art, is mounted to one of the room walls at one side of the mechanism, and the reflector 102 is mounted to an opposite wall across from and at the same height, preferably 3-6 feet up from the floor, as the light beam generator 100. This assembly creates a closed electrical path with the light beam passes unobstructed to the reflector 102 and back to an “eye” (not shown) on the light beam generator 100. The light beam generator 100 is electrically coupled in series to the drive unit 40. The electrical circuit of the drive unit 40 is opened when the light beam is obstructed by a person or object present across its path, which de-energizes the drive unit 40 and prevents it from being lowered.

Rather than being simply electrically in series with the drive unit 40, the light beam generator 100 could be an input to a electronic controller (not shown) which monitors and processes the input as it controls the drive unit 40. In that case, the input signal from the light beam generator 100 could be considered only when the drive unit 40 is lowering the support platform 14, and ignored during when the support platform 14 is being raised. Also, the input signal from the light beam generator 100 could be used by the controller to initiate another event, such as activating an emergency motor brake to immediately stop the support platform 14 or a reverse sequence in which the drive unit is controlled to stop downward movement and begin moving the support platform 14 upward. In any event, a manual override can be required to re-energize the drive unit 40 so that user input is provided to ensure that the area beneath the support platform has been cleared.

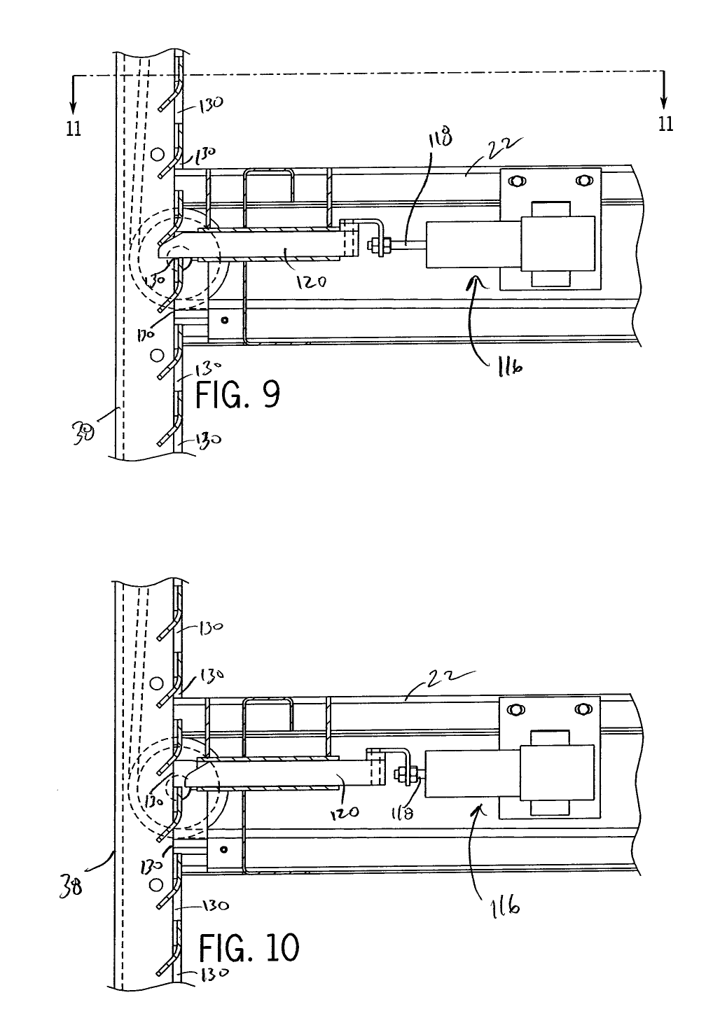

As shown in FIGS. 9-11, the lift mechanism also has a lock out mechanism that positively locks the support platform 14 in at a fixed height or vertical position. The lock out mechanism includes at least one, but preferably four, one at each corner, powered solenoids 110, 112, 114 and 116 that have a pin 118 that can be extended and retracted. Each pin 118 is coupled to an arm 120 extending generally along the axis of the pin. The solenoids 110-116 are mounted along one side of the support platform 14 along a common axis and near opposite corners so that when extended the arms 120 can engage same height pairs of openings in the associated vertical channels 38 of the upright frame assembly 16. The pairs of openings are part of a series of vertically spaced apart openings 130 in the vertical channels 38. Preferably, the arms 120 have tapered upper ends.

The pins 118 of the four solenoids are normally extended by internal springs (not shown), thus the normal attitude of the solenoids are extended. This forces the arms 120 into the openings 130 and into engagement with the vertical channels. To raise the platform the arms 129 are left in the spring loaded out position and the taper on one side of the arms 120 allows them to “cam” or slide over the openings 130 in the vertical channels. The bottom of the arms 120, which is flat, is the only contact area of the arm to the vertical channel, when the platform is at rest. The arms 120 makes a “chunk, chunk, chunk” sound when raising due to each arm 120 slapping into the openings 130. This sound is used to fine tune the cable length when initially setting up the system. If the four cables are set to the correct length, ensuring the platform is level, the four arms 120 slapping against the vertical channel make one combined “chunk” sound. If the cables are of slightly different lengths, indicating an uneven platform the sound is of four distinct chunk sounds.

The lock out mechanism can be activated electrically, either by user input via a button or other interface or via a control algorithm, to positively lock the support platform 14 at a given height. The controls for the lock out mechanism allows the support platform 14 to settle down when the desired height or position is achieved on the vertical channels. The controls “know” where the support platform 14 (and thus the arms 120) are in relationship to the openings 130 in the vertical channels due to a hall sensor counting the revolutions of the motor. When the platform is raised to a position and the arms 120 snap into the opening 130 of the channels, or in the case of lowering when the solenoids withdraw the arms 120 and redeploy them when a lower switch is released, the controls reactivate the drive unit 40 and settles the platform via the arms 120 onto the bottom edge of the openings 130. This removes loading from the cables and pulley carriage 54 of the system as well as optimizes the ability of the user to insert manual travel lock pins that captivate the upper movement of the platform for use when the vehicle/trailer is moving. This arrangement thus provides a positive, mechanical lock out supplemental to the drive unit 40 that better prevents unintended lowering of the support platform 14, which is particularly advantages when lifting heavier loads.

In addition, sensors can be added to the state of the support platform 14 and provide input to control the lock out mechanism. For example, tilt sensors or acceleration sensors that detect a non-level support platform condition or excessive change in travel speed can be used to rapidly deploy the arms 120 into engagement with same height or any other pair of openings 130 in the channels 38, and thereby immediately stop movement, particularly downward movement, of the support platform 14.

It should be appreciated that merely a preferred embodiment of the invention has been described above. However, many modifications and variations to the preferred embodiment will be apparent to those skilled in the art, which will be within the spirit and scope of the invention. Therefore, the invention should not be limited to the described embodiment. To ascertain the full scope of the invention, the following claims should be referenced.

What is claimed is:

1. In a recreational vehicle, a lift mechanism for raising and lowering a platform in an interior of the vehicle, the lift mechanism comprising:
a frame;
a drive assembly;
a support member supporting the platform and connected to the frame to be vertically movable relative to the frame;
an elongated flexible member having a first end fixed relative to the frame and a second end fixed relative to the support member;
at least one movable position guide member engaging the flexible member between first and second ends;
at least one stationary guide member engaging the flexible member between the first and second ends and directing the flexible member through at least one turn;
wherein the drive assembly operates to move the at least one movable position guide member relative to the support member so as to cause the flexible member to adjust the height of the support member.

2. The lift mechanism of claim 1, wherein the drive assembly includes a drive screw and a drive nut engaging the drive screw, wherein the drive screw and the drive nut are relatively rotatable and wherein the position of one of the drive screw and the drive nut is fixed with respect to the at least one movable position guide member.

3. The lift mechanism of claim 2, wherein the drive assembly includes a motor drive for turning one of the drive screw and the drive nut.

4. The lift mechanism of claim 3, wherein the motor drive turns the drive screw.

5. The lift mechanism of claim 1, wherein the drive assembly is mounted to the support member.

6. The lift mechanism of claim 1, further including a bearing assembly accommodating high thrust loads between the drive assembly and the elongated flexible member.

7. The lift mechanism of claim 6, wherein the bearing assembly includes a roller bearing, a spherical washer and a thrust bushing.

8. The lift mechanism of claim 2, further including a carriage to which the at least one movable position guide member is rotatably mounted, the carriage being movable with respect to the support member.

9. The lift mechanism of claim 8, wherein the carriage fixedly mounts the drive nut and travels relative to the support member by rotation of the drive screw.

10. The lift mechanism of claim 8, wherein the carriage mounts a plurality of movable position guide members.

11. The lift mechanism of claim 10, wherein the movable position guide members are double groove sheaves.

12. The lift mechanism of claim 1, wherein the support member is a lateral frame assembly.

13. The lift mechanism of claim 1, wherein the flexible member is a cable and the guide members are rotatable sheaves.

14. The lift mechanism of claim 1, wherein there are at least ten stationary guide members and at least two movable position guide members.

15. The lift mechanism of claim 1, wherein the flexible member includes multiple elongated segments, each segment having a first end coupled together with the first ends of the other segments and fixed relative to the support member and each segment having a second end fixed relative to the vehicle.

16. The lift mechanism of claim 1, wherein the frame includes four channels, one at each corner of the support member.

17. The lift mechanism of claim 1, further including a lock out mechanism for preventing the support member from moving relative to the frame.

18. The lift mechanism of claim 17, wherein the lock out mechanism includes a solenoid for extending and retracting an arm.

19. The lift mechanism of claim 18, wherein the solenoid is mounted to the support member and the arm engages an opening in the frame.

20. The lift mechanism of claim 1, further including a stop mechanism for preventing operation of the drive assembly when an object is beneath the support member.
